(19) United States
(12) Patent Application Publication
(10) Pub. No.: US 2008/0221784 A1
(43) Pub. Date: Sep. 11, 2008

(54) Measurement of Fuel Consumed and of Distance Travelled

(76) Inventor: Meir Ezra, Tel Aviv (IL)

Correspondence Address: YORAM TSIVION, P.O. BOX 1307, PARDES HANNA, 37111, IL

(21) Appl. No.: 11/915,383

(22) PCT Filed: May 25, 2006
(86) PCT No.: PCT/IL06/00615

§ 371 Date: Nov. 25, 2007

Related U.S. Application Data
(60) Provisional application No. 60/684,341, filed on May 25, 2005.

(51) Int. Cl. G01L 3/26

(52) U.S. Cl. 701/123

(57) ABSTRACT

A method for computing significant characteristic parameters of fuel consumption of a vehicle. Fuel consumption data (20) on the one hand and travel distance data (22) or an equivalent thereof on the other hand are collected over time to be processed by a fuel usage procedure. The processing can be done on (24) or off (32) board the vehicle. Distance traveled can be calculated using data obtained on or off board the vehicle.

### FIELD OF THE INVENTION

The present invention is in the field of vehicle fuel consumption. More specifically it is about measuring fuel consumed by vehicles.

### BACKGROUND OF THE INVENTION

The consumption of fuel by vehicles is a function of several factors. Some of the important ones are: motor characteristics, gear characteristics, average velocity and velocity change frequency. Driving proficiency is a factor which may have a considerable influence on the fuel usage efficiency and can be improved by proper training. The vehicle's maintenance level also affects fuel consumption and may be improved. Fuel grade and the usage of proper fuel can also have an affect on the amount and cost of fuel consumed by a vehicle. For supervising the vehicle fuel usage efficiency, it is essential to have a constant survey of the amount of fuel consumed in respect of the distance traveled.

The measurement of fuel consumption can provide information not only with regard to technical aspects of the vehicle, usage and maintenance. It may provide information also as regards possible fraudulent activity such as unauthorized usage or fuel theft. German patent application disclosure DE19941970A1 the contents of which are incorporated herein by reference, describes a method is for recording on board a vehicle the fuel consumption and the distance traveled, thereby enabling for example, to compute the average consumption.

### BRIEF DESCRIPTION OF THE DRAWINGS

FIG. 1A is a block scheme describing in general the data flow and computation in a system measuring and calculating fuel consumption and parameters on board a vehicle;

FIG. 1B is a block scheme describing in general the data flow and computation in a system measuring fuel consumption off board and calculating fuel consumption parameters on board a vehicle;

FIG. 1C is a block scheme describing in general the data flow and computation in a system measuring and calculating fuel consumption on board a vehicle.

### DETAILED DESCRIPTION OF THE PRESENT INVENTION

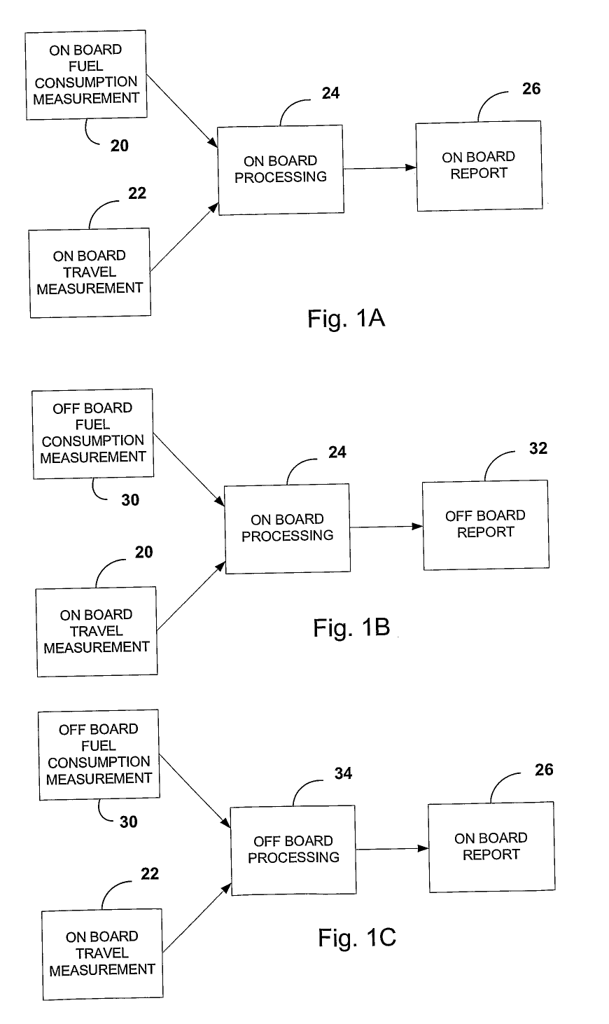

The present invention provides a method for the measurement of significant characteristics of fuel consumption. One simple example to compute fuel consumption characteristics, the amount of fuel consumed is divided by the distance traveled by the vehicle. The method of the invention is implemented in any of a number of schemes, as explained with reference to the block schemes of FIGS. 1A-1C. In the example described schematically in FIG. 1A, all data is collected on board and computations are performed on board the vehicle. Fuel consumption measurement 20, and travel measurement 22 are both performed on board the vehicle as will be elaborated below. The fuel usage calculating process 24 which accomplishes the computation of the significant characteristics of the fuel consumption is also carried out on board the vehicle, and finally, the vehicle also receives the report, typically indicated on a screen to the driver. A different scheme is described in FIG. 1B, in which travel measurement 20 is performed on board the vehicle, but the consumption measurement 30 is done off-board. The computation 24 of the significant characteristics of the fuel consumption is accomplished on board. The fuel consumption report 32 is accomplished off board. In the third scheme, described in FIG. 1C, the fuel consumption measurement 30 is accomplished off board the vehicle and also the processing procedure for computing the significant characteristics of the fuel consumption 34 is accomplished off board. These examples were chosen by virtue of their probable implementation but in effect all combinations are applicable, depending on infrastructure and supportive hardware available.

Measurement of Distance Traveled

To achieve such measurements, several data collection techniques can be employed.

Odometer reading. In case that the odometer is an analog device (mechanical or electronic) reading is to be transformed into a digital format as will be explained later on. If the odometer is a numerator reading, a camera can be employed and image processing algorithm such as known in the art for translating the image into a digital image following which a OCR (optical character recognition) is employed to translate the image into manageable characters (ASCII for example). If the output is electronic a A/A is to be applied using commercial hardware and software.
Flywheel reading. A mark on the flywheel appears each time the flywheel completes a turn. The mark is recorded by a very fast camera and the number of marks per given time is relative to the number of turns of the engine.
Accelerometer reading. An accelerometer detects the acceleration and deceleration along a given momentary axis. A computation of the accelerations and decelerations in the course of time can give a measure of the distance traveled.
Inertial navigation systems. Such systems keep record of the place and position often in the 3D world of moving objects. As such, a navigation system can keep record of distances and directions of vehicles.
Satellite navigation systems. Such navigation systems are used to determine a location of a vehicle. Continuous usage of such navigation enables the constant tracking of the whereabouts of a vehicle. From the successive location tracking it is possible to compute the traveling distances.
Cellular locating. The digital cellular system is basically location sensitive, not only with regards to the identity of the base station connected but also with regards to the distance from the base station. The cellular telephone system can provide some information regarding the location of the mobile set. Other communications services offer various degrees of location accuracy. At present using the cellular system offers an inferior accuracy for locating the vehicle, but more accurate cellular locating systems have been devised and may be put to use in the future.
Interpreting motor sounds. The internal combustion engine driving a vehicle energizes a drive shaft, a fly wheel and several gear sets and other devices all of which spend some of the energy as cyclic noise as well as other mechanical vibrations. The noise and or other mechanical vibrations may be picked up by a suitable sensor, such as a microphone or an accelerometer, to be further transformed into a more or less continuous cyclic electrical signals. The signal is fed to a processing module for amplifying, filtering and further interpreting into revolutions of the engine per unit time (typically related to as RPM). The relationship between the total revolutions of the engine per unit time is equivalent a distance traveled.

Measurement of Fuel Consumed

On-board measuring devices for fuel are ubiquitous, to be found in any vehicle energized by fuel. The method of the invention typically uses either an existing digital output from such a device having a digital output module, or a transform of analog output into appropriate digital numbers, for further processing.

Off-board measuring of fuel consumption uses refueling stations information collecting systems that automatically identify a vehicle and negotiate refueling parameters with the purchasing parameters. Such a information collecting refueling station is disclosed in US patent application US20020014952A1 the contents of which are incorporated herein by reference.

Communications Between the Vehicle and a Monitoring System

In some embodiments of the invention the vehicle is monitored by an external monitoring system. In this description, the term monitoring means the collection of data of the vehicle, of any type as discussed above, computing significant consumption characteristics and issuing reports. Such can be useful in the case of vehicle fleets run by a central agency or belonging to company that uses a fleet of vehicles. A communications event with the vehicle may be accomplished automatically through cellular network communications or through zones of wireless networking or in a communicating fuelling station as disclosed in US20020014952A1. Other communication methods are cellular or satellite telephony.

Justification of the Amount of Fuel Consumed

The close monitoring of the fuel consumption of the vehicle is useful with respect of the fact that a driver or an owner of a vehicle can be made aware of the fuel consumption of the vehicle. Any unjustified consumption figures can be related to faulty mechanical state, theft or bad driving. In a specific application, a central agency looks after a vehicle fleet, such as trucks, and the superintendent may be given reports either automatically or by request of the consumption status. In such cases the driver/user may not be aware of the status reports issued or their contents.

The significant characteristics of the fuel consumption is any useful parameter that relates to the distance traveled with relation to the fuel consumed. Typically, a significant characteristics parameter is the average consumption per distance driven or per time of driving (in terms of seconds, hours, days and weeks). Threshold values can be incorporated into the usage procedure for automatically alerting of an unjustified consumption of fuel.

1. A method for computing at least one significant characteristics parameter of fuel consumption of a vehicle, wherein fuel consumption data on the one hand and travel distance data or an equivalent thereof on the other hand are collected over time to be processed by a fuel usage procedure.

2. a method as in claim 1 and wherein said computation is carried out by an off board processor.

3. A method as in claim 1, wherein said significant characteristics parameters are used for finding unjustified consumption of fuel.

4. A method as in claim 1, wherein said fuel consumption data is obtained by an off board system.

5. A method as in claim 1, wherein said travel distance data is obtained by using navigation data.

6. A method as in claim 1, wherein said travel distance data is obtained by using cellular locating.

7. A method as in claim 1, wherein said travel distance data equivalent is obtained by interpreting mechanical vibrations of said vehicle.
